(19) United States
(12) Patent Application Publication
(10) Pub. No.: US 2011/0025915 A1
(43) Pub. Date: Feb. 3, 2011

(54) Audio and Video Embedded Bedding

(76) Inventor: Aharon Daban, Ashdod (IL)

Correspondence Address: The Law Office of Michael E. Kondoudis, 888 16th Street, N.W., Suite 800, Washington, DC, 20006, US

(21) Appl. No.: 12/866,254

(22) PCT Filed: Feb. 5, 2009
(86) PCT No.: PCT/IL09/00138

§ 371 Date: Oct. 21, 2010

(30) Foreign Application Priority Data
Feb. 6, 2008 (IL) 189331

(51) Int. Cl. H04N 7/00; H04R 5/00

(52) U.S. Cl. 348/552; 381/19; 348/E07.001

(57) ABSTRACT

The present invention provides a bedding system (BS) adapted to be used by any person comprising: (a) a bedding article; and, (b) at least one audio/video means. It should be emphasized that the audio/video means is integrated within said bedding article.

### FIELD OF THE INVENTION

The present invention generally relates to the field of audio/video devices, sensors and monitors adapted to use within a cot, a bed, a mattress, a chair or other ingredients of bedding or sleeping environment.

### BACKGROUND OF THE INVENTION

Prior art—Entertainment and educating devices intended for use by infants, toddlers or children, adults, healthy, handicapped, sick or debilitated persons—audio, video etc; Used in the bedroom or in the bed or in any other part of bedding or a sleeping environment.

Cot bumpers are well-known in the art, and generally comprise flat cushions which are tied to the cot or crib railings and extend down from a region towards the top of the railings to the mattress. They are intended to provide padding against the railings and to prevent a baby's head, legs or arms from being caught in the railings. US patent application No. 2001055931 discloses a rotating musical remote control mobile device with detachable toys. Moreover, UK patent application 20010022105 teaches a bumper for a cot or bed.

The size and construction of existing audio or audio/video devices does not allow for the playing of music within the bedding environment while avoiding interference or possible damage to the sleeping or resting person.

Existing audio or audio/video devices do not contain any sensing or feedback mechanisms adapted for the bedding environment.

Existing Cot bumpers and other bedding items are safe and efficient, but do not contain any added functionality within.

The purpose of present invention is providing an easy, safe and efficient solution for integrating a sound and or video generating, monitoring and sensing device within the bedding environment.

### SUMMARY OF THE INVENTION

It is therefore one object of the present invention to disclose a plan for a voice and video enabled monitoring and sensing bedding environment.

The system comprises a cot bumper, or a mattress, or a pillow, or a bed cover, or other kind bedding item, that contains one or more speaker embedded within, and a wiring system that allows the speaker to connect with an audio or audio/video source, such as CD, DVD, MP3 or MP4 player, which can be integrated within the system, or externally located.

It is one object of the invention to disclose a bedding system (BS) adapted to be used by any person integrally; wherein said BS comprises at least one audio/video means; further wherein said audio/video means are integrated within said BS.

It is another object of the invention to disclose the BS as defined above, comprising at least one, at least partially continuous, integrating portion; said integrating portion is interconnected with said at least one audio/video means in at least temporary or reversible manner.

It is another object of the invention to disclose the BS as defined above, wherein said at least one audio/video means is being interconnected with at least one external connection port.

It is another object of the invention to disclose the BS as defined above, wherein said at least one audio/video means comprises at least one speaker.

It is another object of the invention to disclose the BS as defined above, wherein said audio/video means comprising at least one speaker; said at least one speaker is preferably being in a mono, surround, stereo, quadro or other configuration.

It is another object of the invention to disclose the BS as defined above, wherein said audio/video means comprising at least one display means.

It is another object of the invention to disclose the BS as defined above, wherein said audio/video means is interconnected by at one or more integrating portions.

It is another object of the invention to disclose the BS as defined above, additionally comprising connecting means embedded within said BS.

It is another object of the invention to disclose the BS as defined above, wherein said connecting means are embedded within the integrating portion of said BS.

It is another object of the invention to disclose the BS as defined above, further comprising at least one audio/video player.

It is another object of the invention to disclose the BS as defined above, wherein said at least one audio/video player is selected from a group consisting of radio receiver, CD, DVD, MP3 or MP4 player.

It is another object of the invention to disclose the BS as defined above, further comprising at least one audio/video recorder.

It is another object of the invention to disclose the BS as defined above, wherein said audio/video means is adapted to wireless technology.

It is another object of the invention to disclose the BS as defined above, especially adapted to be utilized in an adult bed, or any other part of an adult sleeping environment or bedding.

It is another object of the invention to disclose the BS as defined above, especially adapted for dental clinics, comprising a part of a dental chair, or of a dental chair cover.

It is another object of the invention to disclose the BS as defined above, especially adapted for medical or surgical clinics and hospitals, especially obstetrics or gynecology clinics; ear nose and throat clinics; ophthalmology clinics; surgical and orthopedic clinics and operating theatres.

It is another object of the invention to disclose the BS as defined above, especially adapted to be utilized in a driver's chair or passenger's chair, fitted to use within any driving or transportation environment or a vehicle.

It is another object of the invention to disclose the BS as defined above, especially adapted to be utilized within a wheelchair, a hospital bed, or rehabilitation bed and adapted for use by sick, injured, debilitated or handicapped people.

It is another object of the invention to disclose the BS as defined above, especially adapted for operation by an automatic timer, which may be mechanical, electromechanical, digital, or computerized and controlled by software.

It is another object of the invention to disclose the BS as defined above, especially adapted for operation by an automatic programmable electrical, digital, computerized or combination thereof feedback mechanism which controls operation parameters such as on/off switching; volume; rhythm; vibration amplitude, frequency and music style.

It is another object of the invention to disclose the BS as defined above, especially adapted for operation by an automatic programmable electrical, digital, computerized or combination thereof feedback mechanism which controls operation parameters such as on/off switching; volume; rhythm; vibration amplitude, frequency and music style wherein said feedback mechanism receives one or more of the following group of input parameters; room light level, movement frequency and amplitude, breathing rate, perspiration index, heart rate, brain electrical activity (EEG), and various other physiological parameters.

It is another object of the invention to disclose the BS as defined above, especially adapted for operation with pulse and respiration rate monitoring devices, connected to an alarm system and to the sound and vibrations generating system through feedback mechanism, which are activated in case of respiratory or cardiac failure.

It is another object of the invention to disclose the BS as defined above, especially adapted with a wireless means of transmitting signals to a remote receiver wherein said wireless means of transmitting signals is located within or in close proximity to said bedding article.

It is another object of the invention to disclose the BS as defined above, especially adapted with a voice triggered wireless means of transmitting signals to a remote receiver.

It is another object of the invention to disclose the BS as defined above, especially adapted with a wireless means of transmitting signals to a remote receiver, muting the audio/video means while transmitting.

It is another object of the invention to disclose the BS as defined above, especially adapted with a microphone and a wireless means of transmitting signals to a remote receiver, muting the audio/video means while transmitting the sounds collected by said microphone.

It is another object of the invention to disclose the BS as defined above, especially adapted with a Sudden Infant Death (SID) syndrome sensor. Such sensor, in a non-limiting manner, may be a respiratory sensor, a movement sensor, a heart rate sensor or any other device to sense the infant's vital signals or any combination thereof.

It is another object of the invention to disclose the BS as defined above, especially provided with a Sudden Infant Death (SID) syndrome sensor, transmitter and remote receiver and designed to sound an alarm when a SID event is registered at said sensor.

It is another object of the invention to disclose the BS as defined above, especially provided with a Sudden Infant Death (SID) syndrome sensor, transmitter and remote receiver and designed to sound an alarm at the receiver when a SID event is registered at said sensor.

It is another object of the invention to disclose the BS as defined above, especially adapted with a wireless means of transmitting audio/video signals to a remote receiver with audio/video means.

It is another object of the invention to disclose the BS as defined above, especially adapted with a 2-way wireless means of transmitting signals to and from a remote receiver.

It is another object of the invention to disclose the BS as defined above, especially adapted with a wireless means of transmitting signals to a remote receiver and said receiver is enabled with a remote controlling means of said audio/video means.

1. It is another object of the invention to disclose a bedding system (BS) (10) comprising
a. a cot bumper body (1-5);
b. at least one pouch (12)
c. at least one compartment and
d. at least one speaker (8a, 8b), mountable on mounting plates (6, 7) and interconnected to at least one audio port

wherein said cot bumper is provided with means of integrating said at least one speaker, and said at least one pouch is provided with means for connection and storage of an audio player; further wherein said at least one compartment is located on said cot bumper body for insertion of the mounted speakers into said cot bumper. It is another object of the invention to disclose the BS as defined above, additionally comprising a cot bumper cover and a zipper (13); said zipper is located on the lower side of said cot bumper; said zipper is adapted to that allows the removal of said cot bumper cover for cleaning or renovation purpose.

It is another object of the invention to disclose the BS as defined above, especially designed with acrylic fibers filling combined with two rigid foamed polyurethane plates and external removable cotton linen cover.

It is another object of the invention to disclose the BS as defined above, wherein each of the cot bumper body parts (2, 3, 4) is of approximately 66 centimeters length.

It is another object of the invention to disclose a bedding system (BS) (24), comprising of a cot bumper body (29); two speakers (27a, 27b) a pouch (26) for connection and storage of an audio player; a mirror on the internal surface (28) and clips on the external surface (25) wherein said cot bumber body, said two speakers, said pouch, mirror and said clips are integrated into a single article.

It is another object of the invention to disclose the BS as defined above, comprising at least one embedded mirror.

It is another object of the invention to disclose the BS as defined above, comprising at least one attached clip on its surface.

It is another object of the invention to disclose the BS as defined above, especially adapted to a mattress comprising a plurality of audio/video means and interconnected by at one or more integrating portions and containing at least one external connection port.

It is another object of the invention to disclose the BS as defined above, especially adapted to a pillow comprising a plurality of audio/video means and interconnected by at one or more integrating portions and containing at least one external connection port.

It is another object of the invention to disclose the BS as defined above, especially adapted to a chair comprising a plurality of audio/video means and interconnected by at one or more integrating portions and containing at least one external connection port.

It is another object of the invention to disclose a method of delivering audio/video content to at least one person comprising the steps of:
a. providing a bedding system (BS) adapted to be used by any person comprising:
   1. a bedding article;
   2. at least one audio/video means
wherein said audio/video means is integrated within said bedding article, and
b. placing said person on or near said BS, and
c. activating said audio/video means to deliver said audio/video content.

It is another object of the invention to disclose a method of delivering audio/video content to at least one person as defined above further comprising a step of providing at least one, at least partially continuous, integrating portion wherein said integrating portion is interconnected with said audio/video means in at least a temporary or reversible manner.

It is another object of the invention to disclose a method of delivering audio/video content to at least one person as defined above wherein said audio/video means is equipped with at least one external connection port.

It is another object of the invention to disclose a method of delivering audio/video content to at least one person as defined above wherein said audio/video means comprises at least one speaker.

It is another object of the invention to disclose a method of delivering audio/video content to at least one person as defined above wherein said at least one speaker is arranged in one or a combination of the following group of configurations: mono, surround, stereo or quadro.

It is another object of the invention to disclose a method of delivering audio/video content to at least one person as defined above wherein said audio/video means comprises at least one display means.

It is another object of the invention to disclose a method of delivering audio/video content to at least one person as defined above wherein said audio/video means is interconnected by one or more integrating portions.

It is another object of the invention to disclose a method of delivering audio/video content to at least one person as defined above further comprising a step of providing connecting means embedded within said BS.

It is another object of the invention to disclose a method of delivering audio/video content to at least one person as defined above wherein said connecting means are embedded within the integrating portion of said BS.

It is another object of the invention to disclose a method of delivering audio/video content to at least one person as defined above further comprising a step of providing at least one audio/video player.

It is another object of the invention to disclose a method of delivering audio/video content to at least one person as defined above further comprising a step of providing at least one audio/video player, wherein said audio/video player is selected from a group consisting of radio receiver, CD, DVD, MP3 or MP4 player.

It is another object of the invention to disclose a method of delivering audio/video content to at least one person as defined above further comprising a step of providing at least one audio/video recorder.

It is another object of the invention to disclose a method of delivering audio/video content to at least one person as defined above wherein said audio/video means is adapted to wireless technology.

It is another object of the invention to disclose a method of delivering audio/video content to at least one person as defined above wherein said BS is especially adapted to be utilized in an adult bed, or any other part of an adult sleeping environment or bedding.

It is another object of the invention to disclose a method of delivering audio/video content to at least one person as defined above wherein said BS is especially adapted for dental clinics, further comprising a step of providing a part of a dental chair or of a dental chair cover.

It is another object of the invention to disclose a method of delivering audio/video content to at least one person as defined above wherein said BS is especially adapted for medical or surgical clinics and hospitals, especially obstetrics or gynecology clinics, ear nose and throat clinics; ophthalmology clinics, surgical and orthopedic clinics and operating theatres.

It is another object of the invention to disclose a method of delivering audio/video content to at least one person as defined above, wherein said BS is especially adapted to be utilized in a driver's chair or passenger's chair, fitted to use within any driving or transportation environment or a vehicle.

It is another object of the invention to disclose a method of delivering audio/video content to at least one person as defined above, wherein said BS is especially adapted to be utilized within a wheelchair, a hospital bed, or rehabilitation bed and adapted for use by sick, injured, debilitated or handicapped people.

It is another object of the invention to disclose a method of delivering audio/video content to at least one person as defined above wherein said BS is especially adapted for operation by an automatic timer, which may be mechanical, electromechanical, digital, or computerized and controlled by software.

It is another object of the invention to disclose a method of delivering audio/video content to at least one person as defined above, wherein said BS is especially adapted for operation by an automatic programmable electrical, digital, computerized or combination thereof feedback mechanism which controls operation parameters such as on/off switching; volume; rhythm; vibration amplitude, frequency and music style. It is another object of the invention to disclose a method of delivering audio/video content to at least one person as defined above, wherein said BS is especially adapted for operation by an automatic programmable electrical, digital, computerized or combination thereof feedback mechanism which controls operation parameters such as on/off switching; volume; rhythm; vibration amplitude, frequency and music style wherein said feedback mechanism receives one or more of the following group of input parameters; room light level, movement frequency and amplitude, breathing rate, perspiration index, heart rate, brain electrical activity (EEG), and various other physiological parameters.

It is another object of the invention to disclose a method of delivering audio/video content to at least one person as defined above, wherein said BS is especially adapted for operation with pulse and respiration rate monitoring devices, connected to an alarm system and to the sound and vibrations generating system through feedback mechanism, which are activated in case of respiratory or cardiac failure.

It is another object of the invention to disclose a method of delivering audio/video content to at least one person as defined above, further comprising the steps of providing said BS with:
a. a wireless transmitter;
b. a wireless receiver,

wherein said wireless transmitter is located within or in close proximity to said bedding article.

It is another object of the invention to disclose a method of delivering audio/video content to at least one person as defined above, wherein said wireless transmitter is triggered by voice.

It is another object of the invention to disclose a method of delivering audio/video content to at least one person as defined above, wherein said wireless transmitter is designed to mute said audio/video means whilst transmitting.

It is another object of the invention to disclose a method of delivering audio/video content to at least one person as defined above, wherein said wireless transmitter comprises a microphone and broadcasts the sounds collected by said microphone.

It is another object of the invention to disclose a method of delivering audio/video content to at least one person as defined above, further comprising the step of providing a means to sense Sudden Infant Death (SID) syndrome events occurring to an infant using said BS.

It is another object of the invention to disclose a method of delivering audio/video content to at least one person as defined above, wherein said transmitter is provided with means to sound an alarm upon receiving indication from said sensing means of a Sudden Infant Death (SID) syndrome event taking place.

It is another object of the invention to disclose a method of delivering audio/video content to at least one person as defined above, wherein said transmitter is provided with means to transmit an alarm signal to said receiver upon receiving indication from said means of sensing Sudden Infant Death (SID) syndrome events.

It is another object of the invention to disclose a method of delivering audio/video content to at least one person as defined above, wherein said transmitter can broadcast audio/video signals to said receiver.

It is another object of the invention to disclose a method of delivering audio/video content to at least one person as defined above, wherein said receiver can transmit to said audio/video means.

It is another object of the invention to disclose a method of delivering audio/video content to at least one person as defined above, wherein said receiver controls said audio/video means.

It is another object of the invention to disclose a method of delivering audio/video content to at least one person comprising the step of:
a. providing a Bedding System (BS) (10), comprising:
   1. a cot bumper body (1-5);
   2. at least one pouch (12)
   3. at least one compartment and
   4. at least one speaker (8a, 8b), mountable on mounting plates (6, 7) and interconnected to at least one audio port

wherein said cot bumper is provided with means of integrating said at least one speaker, and said at least one pouch is provided with means for connection and storage of an audio player; further wherein said at least one compartment is located on said cot bumper body for insertion of the mounted speakers into said cot bumper.
b. placing said person on or near said BS, and
c. activating said at least one speaker to deliver said audio/video content.

It is another object of the invention to disclose a method of delivering audio/video content to at least one person as defined above, further comprising the step of providing a cot bumper cover and a zipper (13) wherein said zipper is located on the lower side of said cot bumper; said zipper is adapted to allow the removal of said cot bumper cover.

It is another object of the invention to disclose a method of delivering audio/video content to at least one person as defined above, wherein said BS further comprises of:
a. acrylic fibers filling;
b. two rigid foamed polyurethane plates;
c. external removable cotton linen cover.

It is another object of the invention to disclose a method of delivering audio/video content to at least one person as defined above, wherein each of the BS body parts 2, 3 and 4 is approximately of 66 centimeters length.

It is another object of the invention to disclose a method of delivering audio/video content to at least one person, comprising the steps of:
a. providing a bedding system (BS) (24), comprising of:
   1. a cot bumper body (29);
   2. two speakers (27a, 27b);
   3. a pouch (26) for connection and storage of an audio player;
   4. a mirror on the internal surface (28);
   5. clips on the external surface (25).
b. placing said person on or near said BS, and
c. activating said audio/video means to deliver said audio/video content.

It is another object of the invention to disclose a method of delivering audio/video content to at least one person as defined above, further comprising a step of providing at least one mirror embedded in said bedding article.

It is another object of the invention to disclose a method of delivering audio/video content to at least one person as defined above, further comprising a step of providing at least one clip attached to the surface of said bedding article.

It is another object of the invention to disclose a method of delivering audio/video content to at least one person as defined above, further comprising a step of providing at least one external connection port and especially adapted to a mattress and a plurality of audio/video means and interconnected by one or more integrating portions.

It is another object of the invention to disclose a method of delivering audio/video content to at least one person as defined above, further comprising a step of providing at least one external connection port and especially adapted to a pillow and a plurality of audio/video means and interconnected by one or more integrating portions.

It is another object of the invention to disclose a method of delivering audio/video content to at least one person as defined above, further comprising a step of providing at least one external connection port and especially adapted to a chair and a plurality of audio/video means and interconnected by one or more integrating portions.

It is another object of the invention to disclose a method of entertaining a person, or a driver or a passenger in any transportation vehicle using bedding integrally comprising at least one audio/video means; said method comprising step applying audio/video content to said person which is of amusing, entertaining or relaxing nature.

It is another object of the invention to disclose a method of providing relaxation and anxiety removal during a psychotherapy session or during treatment in a dental, medical or surgical clinic using bedding integrally comprising at least one audio/video means; said method comprising step of applying audio/video content to said person which is of relaxing nature.

It is another object of the invention to disclose a method of educating, mentally developing, instructing, teaching, training a person using bedding integrally comprising at least one audio/video means; said method comprising step of applying audio/video content to said person which is of educating, training, tutoring or mentally developing nature.

It is another object of the invention to disclose a method of monitoring an infant comprising step of obtaining the device as defined above and operating the integrated monitoring system, which will be activated by respiratory or cardiac arrest in order to prevent Sudden Infant Death (SID) syndrome.

It is still an object of the invention to disclose a method of monitoring any sick, injured or handicapped person comprising step of obtaining the device as defined above and operating the integrated monitoring system, which will be activated by respiratory or cardiac arrest, or predetermined changes in other monitored physiological parameters.

It is lastly an object of the invention to disclose a method of maintaining the wakefulness of a person, who is a driver of any type of vehicle; said method comprising step of obtaining the device as defined above and operating the integrated monitoring and feedback system wherein applying audio/video/vibratory content to said person which is of relaxing or alarming nature, determined manually or automatically by monitoring input.

### BRIEF DESCRIPTION OF THE DRAWINGS

In order to understand the invention and to see how it may be implemented in practice, a preferred embodiment will now be described, by way of non-limiting example only, with reference to the accompanying drawings, in which

FIG. 1 illustrates the cot bumper bedding system according to the present invention;

FIG. 2 illustrates the internal wiring if the speakers within the cot bumper, and connection to external audio source;

FIG. 3 is a sectional view of the cot bumper internal aspect;

FIG. 4 illustrates a lower side view of the cot bumper;

FIG. 5 illustrates a side view of the bedding system illustrated in FIGS. 1 to 3;

FIG. 6 illustrates an internal view of the bedding system illustrated in FIGS. 1 to 3;

FIG. 7 illustrates an external view of the bedding system illustrated in FIGS. 1 to 3;

FIG. 8 illustrates an internal view, a side view and an external view of the bedding system.

FIG. 9 illustrates an audio enabled bedding system;

FIG. 10 illustrates the cot bumper according to another embodiment of the present invention;

FIG. 11 illustrates the cot bumper according to another embodiment of the present invention;

### DETAILED DESCRIPTION OF THE EMBODIMENTS

The following description is provided, alongside all chapters of the present invention, so as to enable any person skilled in the art to make use of the said invention and sets forth the best modes considered by the inventor for carrying out this invention. Various modifications, however, will remain apparent to those skilled in the art, since the generic principles of the present invention have been defined specifically to provide bedding system integrally comprising at least one audio/video means.

The term ‘bedding system’ refers hereinafter to a mattress, pillow, blanket or quilt, bedspread, counterpane, coverlet, cot bumper, and all other means adapted to be used within a resting, sleeping or sitting environment, thus also including any type of chair—armchair, couch, sofa, divan, studio couch, etc, and also specialized chair types such as dentist's chair or any other chair used for medical examination or procedure (such as in a gynecologist's clinic), a driver's chair, any type of a chair cover, any combination thereof of any system comprising the same.

Said bedding system essentially comprises at least one ‘integrating portion’. The integrating portion of the bedding system is preferably, yet not exclusively, made of washable rages, especially cotton, polymers, preferably Nylons cardboard, paper products, acrylic fibers or polyurethane polymers.

The term ‘cot’ refers hereinafter to any bed, crib, or any other item used for sleeping or resting purpose.

The term ‘Cot bumper’ refers hereinafter to any type of cushions which are tied to the cot or crib railings. The bumper may be made of any suitable materials that provide for a cushioning/padding effect. The bumper may be of a single unitary structure, or may comprise separate side and head portions that are able to fit together. It may be further covered in a suitable outer cover that may be removable, e.g. in pillowcase style, by a zip or buttons, or in any other suitable manner, for cleaning purposes. The item may be inflatable with air, gas or fluid.

The term ‘mattress’ refers hereinafter to any surface used for sleeping or resting purpose. The item may be inflatable with air, gas or fluid.

The term ‘pillow’ refers hereinafter to any surface used for head rest. The item may be inflatable with air, gas or fluid.

The term ‘audio/video means’ refers hereinafter to any sound generating means and/or video generating means and/or vibration generating means, being selected in a non-limiting manner form a group including speakers, loudspeakers and subwoofers, lamps, Leads, LCDs, LASERs, screens, vibrators, oscillators or any combination thereof. The audio/video means may comprise audio/video player and/or audio/video content.

The term ‘mounting plate’ refers hereinafter to any plate, flexible or rigid, which is suitable to contain a speaker mounted on it.

The term ‘audio source connection’ refers hereinafter to any connection type, whether regular or wireless.

The term ‘screen’ refers hereinafter to any screen or other displaying means, including in a non-limiting manner lamps, LCDs, lasers, CRT, plasma, or LEDS.

The term ‘audio/video content’ refers hereinafter to any sound or movie, including in a non-limiting manner signal, music, melody, motion picture, film or television show.

The term ‘audio/video player’ refers hereinafter to any device capable of generating audio or video content including in a non-limiting manner CD, DVD, MP3, MP4, video, tape and record players.

The term ‘integrally comprising’ refers hereinafter to any device or method that incorporate and/or embed and/or encapsulate and/or envelop and/or accommodate at least one ‘audio/video means’ in a bedding system as defined in any of the above.

The term ‘person’ refers hereinafter to an infant, toddler, child or an adult, whether healthy or sick, handicapped or debilitated.

The term ‘clip’ refers hereinafter to any flexible or spring-loaded device for holding an object or objects together or in place.

The term ‘mirror’ refers hereinafter to any surface with good specular reflection that is smooth enough to form an image.

The term “Sudden infant death syndrome (SID)” refers hereinafter to a syndrome marked by the symptoms of sudden and unexplained death of an apparently healthy infant aged one month to one year.

The term “about” refers hereinafter to a range of 25% below or above the referred value.

The term “wireless” refers hereinafter to any means of communication between devices that is not transmitted through a wire. Examples of such means include Wifi, Wimax, Bluetooth, radio and IR frequency communication.

It is according to one embodiment of the present invention wherein the bedding system integrally comprises at least one audio/video means, and further comprises at least one, at least partially continuous, integrating portion; said integrating matter is interconnected with said at least one audio/video means in at least temporary or reversible manner.

It is according to another embodiment of the present invention wherein the at least one audio/video means is being interconnected with at least one external connection port.

It is according to another embodiment of the present invention wherein the audio/video means comprises at least one speaker.

It is according to another embodiment of the present invention wherein said at least one speaker is arranged in one or a combination of the following group of configurations: mono, surround, stereo or quadro.

It is according to another embodiment of the present invention wherein the audio/video means comprises of at least one display means.

It is according to another embodiment of the present invention wherein the plurality of audio/video means is interconnected by at one or more integrating portions.

It is according to another embodiment of the present invention wherein the connecting means are embedded within said bedding system. Alternatively or additionally, the connecting means are embedded within the integrating portion of said bedding system.

It is according to another embodiment of the present invention wherein the bedding system as defined in any of the above further comprises at least one audio/video player.

It is according to another embodiment of the present invention wherein the least one audio/video player is selected from radio receiver, CD, DVD, MP3 or MP4 player.

It is according to another embodiment of the present invention wherein the bedding system as defined in any of the above further comprises at least one audio/video recorder.

It is according to another embodiment of the present invention wherein the audio/video means is adapted to wireless technology.

It is according to another embodiment of the present invention wherein the aforesaid bedding system is adapted in a non-limiting manner to baby cradle, crib or cot, or any other part of baby/infant/toddler/child sleeping or bedding system environment.

It is according to another embodiment of the present invention wherein the bedding system as defined in any of the above further comprising at least one mirror.

It is according to another embodiment of the present invention wherein the bedding system as defined in any of the above further comprising at least one clip.

It is according to another embodiment of the present invention wherein the aforesaid bedding system is adapted in a non-limiting manner to adapted to be utilized in an adult bed, or any other part of an adult sleeping environment or bedding system

It is according to another embodiment of the present invention wherein the aforesaid bedding system is adapted in a non-limiting manner to dental clinics, especially comprising a part, of a dental chair or its cover.

It is according to another embodiment of the present invention wherein the aforesaid bedding system is adapted in a non-limiting manner to be utilized in medical or surgical clinics and hospitals, especially obstetrics or gynecology clinics; ear nose and throat clinics; ophthalmology clinics; surgical and orthopedic clinics and operating theatres.

It is according to another embodiment of the present invention wherein the aforesaid bedding system is adapted in a non-limiting manner to be utilized in a driver's chair or passenger's chair, fitted to use within any driving or transportation environment or vehicle.

It is according to another embodiment of the present invention wherein the aforesaid bedding system is adapted in a non-limiting manner to be embedded within a wheelchair, a hospital bed, or rehabilitation bed and adapted for use by sick, injured, debilitated or handicapped people.

It is according to another embodiment of the present invention wherein the aforesaid bedding system is adapted in a non-limiting manner for operation by an automatic timer, which may be mechanical, electromechanical, digital, or computerized and controlled by software.

It is according to another embodiment of the present invention wherein the aforesaid bedding system is integrated with an automatic programmable electrical, digital, or computerized feedback mechanism, which control operation parameters such as on/off switching; volume; rhythm; vibration amplitude and frequency and music style. It is according to another embodiment of the present invention wherein the aforesaid bedding system wherein said feedback mechanism may receive one or more of the following group of input parameters: room light level, movement frequency and amplitude, breathing rate, perspiration index, heart rate, brain electrical activity (EEG), and various other physiological parameters.

It is according to another embodiment of the present invention wherein the aforesaid bedding system is adapted in a non-limiting manner to integrated with pulse and respiration rate monitoring devices, connected to an alarm system and to the sound and vibrations generating system through feedback mechanism, which are activated in case of respiratory or cardiac failure.

It is according to another embodiment of the present invention wherein the aforesaid bedding system is adapted with a wireless means of transmitting signals to a remote receiver.

It is according to another embodiment of the present invention wherein the aforesaid bedding system is adapted with a voice triggered wireless means of transmitting signals to a remote receiver.

It is according to another embodiment of the present invention wherein the aforesaid bedding system is adapted with a wireless means of transmitting signals to a remote receiver, muting the audio/video means while transmitting.

It is according to another embodiment of the present invention wherein the aforesaid bedding system is adapted with a microphone and a wireless means of transmitting signals to a remote receiver, muting the audio/video means while transmitting the sounds collected by said microphone.

It is according to another embodiment of the present invention wherein the aforesaid bedding system is adapted with a Sudden Infant Death (SID) syndrome sensor. Such sensor, in a non-limiting manner, may be a respiratory sensor, a movement sensor, a heart rate sensor or any other device to sense the infant's vital signals.

It is according to another embodiment of the present invention wherein the aforesaid bedding system is adapted with a Sudden Infant Death (SID) syndrome sensor, transmitter and remote receiver and designed to sound an alarm at the receiver when a SID event is registered at said sensor.

It is according to another embodiment of the present invention wherein the aforesaid bedding system is adapted with a wireless means of transmitting audio/video signals to a remote receiver with audio/video means.

It is according to another embodiment of the present invention wherein the aforesaid bedding system is adapted with a 2-way wireless means of transmitting signals to and from a remote receiver.

It is according to another embodiment of the present invention wherein the aforesaid bedding system is adapted with a wireless means of transmitting signals to a remote receiver and said receiver is enabled with a remote controlling means of said audio/video means.
a. It is according to another embodiment of the present invention wherein the bedding system (10) comprises: a cot bumper body (1-5);
b. at least one pouch (12)
c. at least one compartment and
d. at least one speaker (8a, 8b), mountable on mounting plates (6, 7) and interconnected to at least one audio port

wherein said cot bumper is provided with means of integrating said at least one speaker, and said at least one pouch is provided with means for connection and storage of an audio player; further wherein said at least one compartment is located on said cot bumper body for insertion of the mounted speakers into said cot bumper. It is according to another embodiment of the present invention wherein the aforesaid bedding system can be used as a method of entertaining a person, additionally comprising a cot bumper cover and a zipper (13) wherein said zipper is located on the lower side of said cot bumper; said zipper is adapted to allow the removal of said cot bumper cover.

It is according to another embodiment of the present invention, wherein the aforesaid bedding system can be used as a method of entertaining a person, wherein said cot bumper further comprises of:
a. acrylic fibers filling;
b. two rigid foamed polyurethane plates;
c. external removable cotton linen cover.

It is according to another embodiment of the present invention, wherein each of the cot bumper body parts 2, 3 and 4 is approximately of 66 centimeters length.

It is according to another embodiment of the present invention, wherein the bedding system (BS) (24), comprises of:
a. a cot bumper body (29);
b. two speakers (27a, 27b);
c. a pouch (26) for connection and storage of an audio player;
d. a mirror on the internal surface (28);
e. clips on the external surface (25)

wherein said cot bumber body , said two speakers, said pouch, mirror and said clips are integrated into a single article.

It is according to another embodiment of the present invention wherein the aforesaid bedding system, further comprises at least mirror embedded in said bedding article.

It is according to another embodiment of the present invention wherein the aforesaid bedding system, further comprising at least one clip attached to the surface of said bedding article.

It is according to another embodiment of the present invention wherein the aforesaid bedding system is especially adapted to a mattress comprising a plurality of audio/video means and interconnected by one or more integrating portions and further comprising at least one external connection port.

It is according to another embodiment of the present invention wherein the aforesaid bedding system, is especially adapted to a pillow comprising a plurality of audio/video means and interconnected by one or more integrating portions and further comprising at least one external connection port.

It is according to another embodiment of the present invention wherein the aforesaid bedding system, is especially adapted to a chair comprising a plurality of audio/video means and interconnected by one or more integrating portions and further comprising at least one external connection port.

It is according to another embodiment of the present invention wherein the aforesaid bedding system can be used as a method of delivering audio/video content to at least one person comprising the steps of:
a. providing a bedding system (BS) adapted to be used by any person comprising:
   1. a bedding article;
   2. at least one audio/video means
wherein said audio/video means is integrated within said bedding article, and
b. placing said person on or near said BS, and
c. activating said audio/video means to deliver said audio/video content.

It is according to another embodiment of the present invention wherein the aforesaid bedding system can be used as a method of delivering audio/video content to at least one person further comprising a step of providing at least one, at least partially continuous, integrating portion wherein said integrating portion is interconnected with said audio/video means in at least a temporary or reversible manner.

It is according to another embodiment of the present invention wherein the aforesaid bedding system can be used as a method of delivering audio/video content to at least one person wherein said audio/video means is equipped with at least one external connection port.

It is according to another embodiment of the present invention wherein the aforesaid bedding system can be used as a method of delivering audio/video content to at least one person said audio/video means comprises at least one speaker.

It is according to another embodiment of the present invention wherein the aforesaid bedding system can be used as a method of delivering audio/video content to at least one person wherein said at least one speaker is arranged in one or a combination of the following group of configurations: mono, surround, stereo or quadro.

It is according to another embodiment of the present invention wherein the aforesaid bedding system can be used as a method of delivering audio/video content to at least one person wherein said audio/video means comprises at least one display means.

It is according to another embodiment of the present invention wherein the aforesaid bedding system can be used as a method of delivering audio/video content to at least one person, wherein said audio/video means is interconnected by one or more integrating portions.

It is according to another embodiment of the present invention wherein the aforesaid bedding system can be used as a method of delivering audio/video content to at least one person further comprising a step of providing connecting means embedded within said BS.

It is according to another embodiment of the present invention wherein the aforesaid bedding system can be used as a method of delivering audio/video content to at least one person wherein said connecting means are embedded within the integrating portion of said BS.

It is according to another embodiment of the present invention wherein the aforesaid bedding system can be used as a method of delivering audio/video content to at least one person, further comprising a step of providing at least one audio/video player.

It is according to another embodiment of the present invention wherein the aforesaid bedding system can be used as a method of delivering audio/video content to at least one person, wherein said audio/video player is selected from a group consisting of radio receiver, CD, DVD, MP3 or MP4 player.

It is according to another embodiment of the present invention wherein the aforesaid bedding system can be used as a method of delivering audio/video content to at least one person further comprising a step of providing at least one audio/video recorder.

It is according to another embodiment of the present invention wherein the aforesaid bedding system can be used as a method of delivering audio/video content to at least one person wherein said audio/video means is adapted to wireless technology.

It is according to another embodiment of the present invention wherein the aforesaid bedding system can be used as a method of delivering audio/video content to at least one person wherein said BS is especially adapted to be utilized in an adult bed, or any other part of an adult sleeping environment or bedding.

It is according to another embodiment of the present invention wherein the aforesaid bedding system can be used as a method of delivering audio/video content to at least one person wherein said BS is especially adapted for dental clinics, further comprising a step of providing a part of a dental chair or of a dental chair cover.

It is according to another embodiment of the present invention wherein the aforesaid bedding system can be used as a method of delivering audio/video content to at least one person wherein said BS is especially adapted for medical or surgical clinics and hospitals, especially obstetrics or gynecology clinics, ear nose and throat clinics; ophthalmology clinics, surgical and orthopedic clinics and operating theatres.

It is according to another embodiment of the present invention wherein the aforesaid bedding system can be used as a method of delivering audio/video content to at least one person wherein said BS is especially adapted to be utilized in a driver's chair or passenger's chair, fitted to use within any driving or transportation environment or a vehicle.

It is according to another embodiment of the present invention wherein the aforesaid bedding system can be used as a method of delivering audio/video content to at least one person wherein said BS is especially adapted to be utilized within a wheelchair, a hospital bed, or rehabilitation bed and adapted for use by sick, injured, debilitated or handicapped people.

It is according to another embodiment of the present invention wherein the aforesaid bedding system can be used as a method of delivering audio/video content to at least one person wherein said BS is especially adapted for operation by an automatic timer, which may be mechanical, electromechanical, digital, or computerized and controlled by software.

It is according to another embodiment of the present invention wherein the aforesaid bedding system can be used as a method of delivering audio/video content to at least one person wherein said BS is especially adapted for operation by an automatic programmable electrical, digital, computerized or combination thereof feedback mechanism which controls operation parameters such as on/off switching; volume; rhythm; vibration amplitude, frequency and music style.

It is according to another embodiment of the present invention wherein the aforesaid bedding system can be used as a method of delivering audio/video content to at least one person wherein said feedback mechanism receives one or more of the following group of input parameters; room light level, movement frequency and amplitude, breathing rate, perspiration index, heart rate, brain electrical activity (EEG), and various other physiological parameters.

It is according to another embodiment of the present invention wherein the aforesaid bedding system can be used as a method of delivering audio/video content to at least one person wherein said BS is especially adapted for operation with pulse and respiration rate monitoring devices, connected to an alarm system and to the sound and vibrations generating system through feedback mechanism, which are activated in case of respiratory or cardiac failure.

It is according to another embodiment of the present invention wherein the aforesaid bedding system can be used as a method of delivering audio/video content to at least one person further comprising the steps of providing said BS with:
a. a wireless transmitter;
b. a wireless receiver,

wherein said wireless transmitter is located within or in close proximity to said bedding article.

It is according to another embodiment of the present invention wherein the aforesaid bedding system can be used as a method of delivering audio/video content to at least one person wherein said wireless transmitter is triggered by voice.

It is according to another embodiment of the present invention wherein the aforesaid bedding system can be used as a method of delivering audio/video content to at least one person wherein said wireless transmitter is designed to mute said audio/video means whilst transmitting.

It is according to another embodiment of the present invention wherein the aforesaid bedding system can be used as a method of delivering audio/video content to at least one person wherein said wireless transmitter comprises a microphone and broadcasts the sounds collected by said microphone.

It is according to another embodiment of the present invention wherein the aforesaid bedding system can be used as a method of delivering audio/video content to at least one person further comprising the step of providing a means to sense Sudden Infant Death (SID) syndrome events occurring to an infant using said BS.

It is according to another embodiment of the present invention wherein the aforesaid bedding system can be used as a method of delivering audio/video content to at least one person wherein said transmitter is provided with means to sound an alarm upon receiving indication from said sensing means of a Sudden Infant Death (SID) syndrome event taking place.

It is according to another embodiment of the present invention wherein the aforesaid bedding system can be used as a method of delivering audio/video content to at least one person wherein said transmitter is provided with means to transmit an alarm signal to said receiver upon receiving indication from said means of sensing Sudden Infant Death (SID) syndrome events.

It is according to another embodiment of the present invention wherein the aforesaid bedding system can be used as a method of delivering audio/video content to at least one person wherein said transmitter can broadcast audio/video signals to said receiver.

It is according to another embodiment of the present invention wherein the aforesaid bedding system can be used as a method of delivering audio/video content to at least one person wherein said receiver can transmit to said audio/video means.

It is according to another embodiment of the present invention wherein the aforesaid bedding system can be used as a method of delivering audio/video content to at least one person wherein said receiver controls said audio/video means.

It is according to another embodiment of the present invention wherein the aforesaid bedding system can be used as a method of delivering audio/video content to at least one person comprising the steps of:
a. providing a Bedding System (BS) (10), comprising:
   1. a cot bumper body (1-5);
   2. at least one pouch (12)
   3. at least one compartment and
   4. at least one speaker (8a, 8b), mountable on mounting plates (6, 7) and interconnected to at least one audio port

wherein said cot bumper is provided with means of integrating said at least one speaker, and said at least one pouch is provided with means for connection and storage of an audio player; further wherein said at least one compartment is located on said cot bumper body for insertion of the mounted speakers into said cot bumper.
b. placing said person on or near said BS, and
c. activating said at least one speaker to deliver said audio/video content.

It is according to another embodiment of the present invention wherein the aforesaid bedding system can be used as a method of delivering audio/video content to at least one person further comprising the step of providing a cot bumper cover and a zipper (13) wherein said zipper is located on the lower side of said cot bumper; said zipper is adapted to allow the removal of said cot bumper cover.

It is according to another embodiment of the present invention wherein the aforesaid bedding system can be used as a method of delivering audio/video content to at least one person wherein said BS further comprises of:
a. acrylic fibers filling;
b. two rigid foamed polyurethane plates;
c. external removable cotton linen cover.

It is according to another embodiment of the present invention wherein the aforesaid bedding system can be used as a method of delivering audio/video content to at least one person wherein each of the BS body parts 2, 3 and 4 is approximately of 66 centimeters length.

It is according to another embodiment of the present invention wherein the aforesaid bedding system can be used as a method of delivering audio/video content to at least one person comprising the steps of:
a. providing a bedding system (BS) (24), comprising of:
   1. a cot bumper body (29);
   2. two speakers (27a, 27b);
   3. a pouch (26) for connection and storage of an audio player;
   4. a mirror on the internal surface (28);
   5. clips on the external surface (25).
b. placing said person on or near said BS, and
c. activating said audio/video means to deliver said audio/video content.

It is according to another embodiment of the present invention wherein the aforesaid bedding system can be used as a method of delivering audio/video content to at least one person further comprising a step of providing at least one mirror embedded in said bedding article.

It is according to another embodiment of the present invention wherein the aforesaid bedding system can be used as a method of delivering audio/video content to at least one person further comprising a step of providing at least one clip attached to the surface of said bedding article.

It is according to another embodiment of the present invention wherein the aforesaid bedding system can be used as a method of delivering audio/video content to at least one person further comprising a step of providing at least one external connection port and especially adapted to a mattress and a plurality of audio/video means and interconnected by one or more integrating portions.

It is according to another embodiment of the present invention wherein the aforesaid bedding system can be used as a method of delivering audio/video content to at least one person further comprising a step of providing at least one external connection port and especially adapted to a pillow and a plurality of audio/video means and interconnected by one or more integrating portions.

It is according to another embodiment of the present invention wherein the aforesaid bedding system can be used as a method of delivering audio/video content to at least one person further comprising a step of providing at least one external connection port and especially adapted to a chair and a plurality of audio/video means and interconnected by one or more integrating portions.

It is according to another embodiment of the present invention wherein the aforesaid bedding system can be used as a method of entertaining a person, or a driver or a passenger in any transportation vehicle using bedding system integrally comprising at least one audio/video means; said method comprising applying audio/video content to said person which is of amusing, entertaining or relaxing nature.

It is according to another embodiment of the present invention wherein the aforesaid bedding system can be used as a method of providing relaxation and anxiety removal during a psychotherapy session or during treatment in a dental, medical or surgical clinic using bedding system integrally comprising at least one audio/video means; said method comprising applying audio/video content to said person which is of relaxing nature.

It is according to another embodiment of the present invention wherein the aforesaid bedding system can be used as a method of educating, mentally developing, instructing, teaching, training a person using bedding system integrally comprising at least one audio/video means; said method comprising applying audio/video content to said person which is of educating, training, tutoring or mentally developing nature.

It is according to another embodiment of the present invention wherein the aforesaid bedding system can be used as a method of monitoring an infant, comprising bedding system with integrated monitoring system, which will be activated by respiratory or cardiac arrest in order to prevent Sudden Infant Death (SID) syndrome.

It is according to another embodiment of the present invention wherein the aforesaid bedding system can be used as a method of monitoring any sick, injured or handicapped person comprising bedding system with integrated monitoring system, which will be activated by respiratory or cardiac arrest, or predetermined changes in other monitored physiological parameters.

It is according to another embodiment of the present invention wherein the aforesaid bedding system can be used as a method of maintaining the wakefulness of a person, who is a driver of any type of vehicle, comprising bedding system with integrated monitoring and feedback system wherein applying audio/video/vibratory content to said person which is of relaxing or alarming nature, determined manually or automatically by monitoring input.

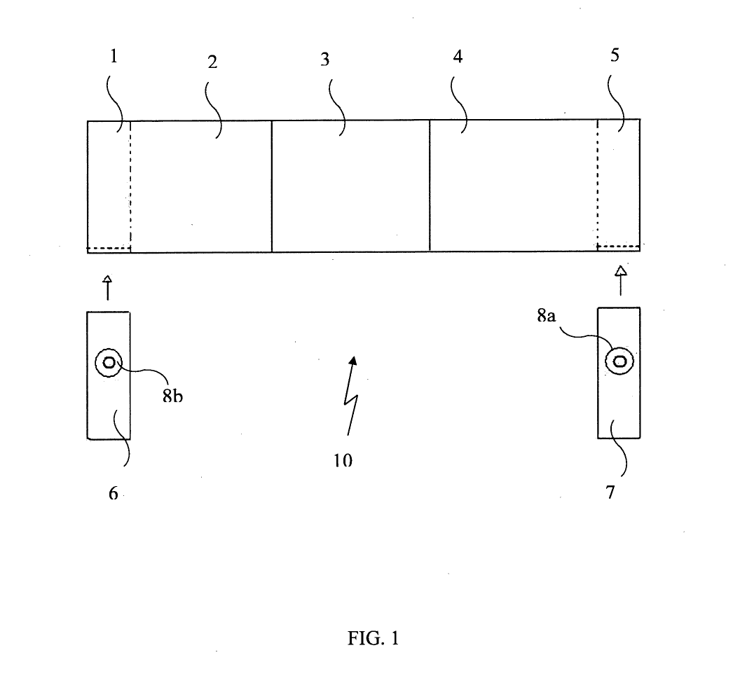

Reference is now made to FIG. 1 which displays the cot bumper bedding system (10) according to one embodiment of the present invention. The cot bumper bedding system (10) comprises inter alia a first speaker (8a) and a second speaker (8b). The speakers are mounted on plates (6,7) that can be inserted within dedicated spaces (1,5) located on the sides of the cot bumper. The cot bumper (10) may comprise internal wiring that connects the cot bumper bedding system (10) to an audio source. Parts 2 and 3 are body parts of the cot bumper (10). It should be out that the present invention is not limited to two body part (2, 3) and it may comprise more (4) or less body parts.

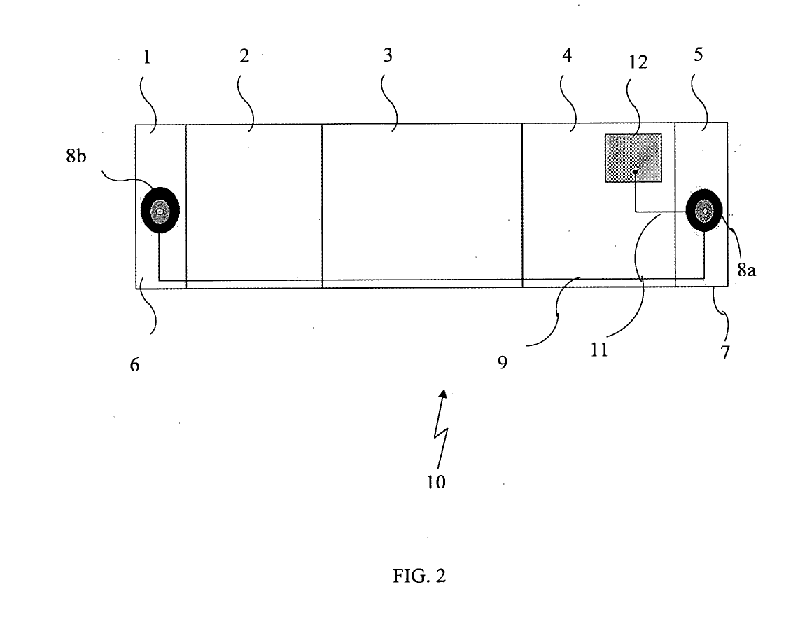

Reference is now made to FIG. 2 which illustrates the internal electrical wiring between the speakers. The speakers (8a,8b) are interconnected by electrical wires (9), that connects to another wire (11), which connects to an external audio source, which may be external, or be internally placed within space (12) of the cot bumper. The wires marked by (9,11) have redundant length, in order to be protected against accidental pulling. The connection may be wireless.

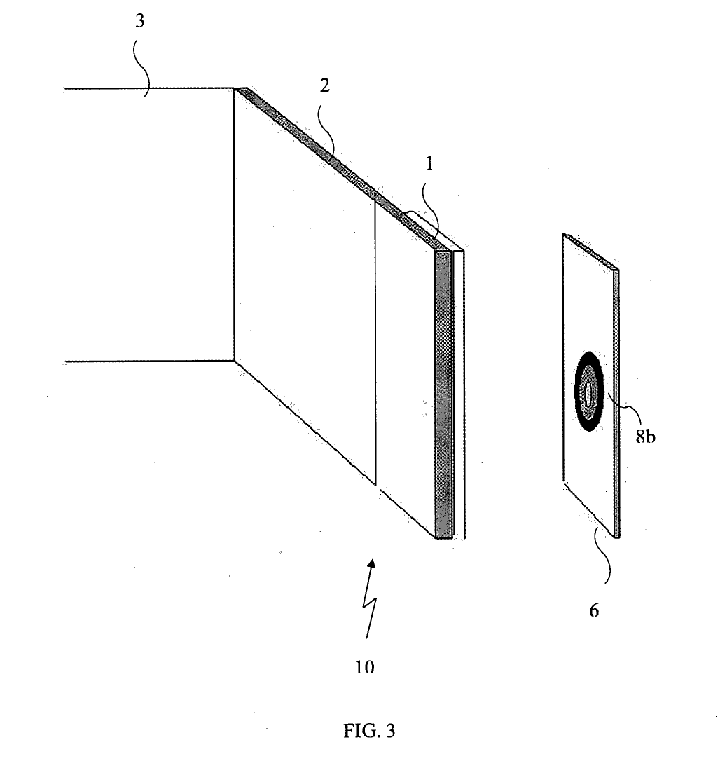

Reference is now made to FIG. 3, which illustrates a sectional view of the cot bumper internal aspect, according to one specific embodiment of the present invention. As can be seen from the figure the cot bumper comprises inter alia cot bumper body parts (2,3), a speaker (8b or 8a) mounted on the mounting plate (6 or 7), and a dedicated space (1 or 5) for insertion of the mounted speaker into the cot bumper (10). It should be pointed out that the present invention is not limited to one speaker and more than one may be used.

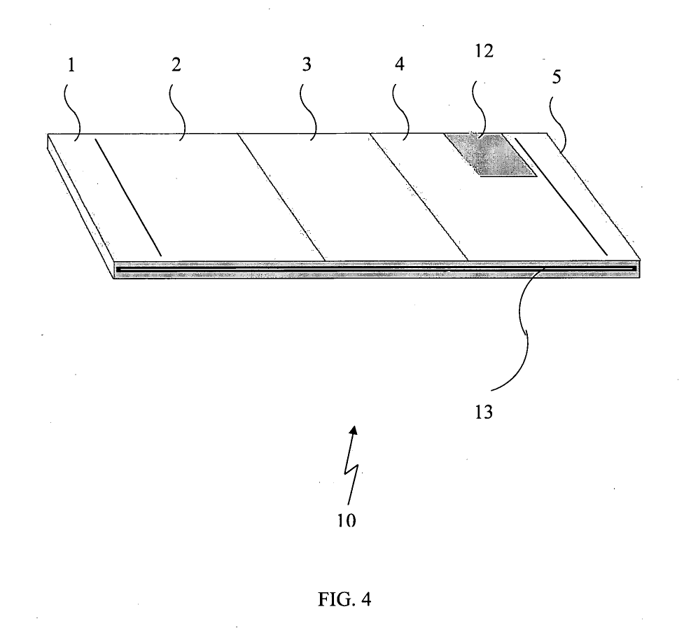

Reference is now made to FIG. 4, illustrating a lower side view of the cot bumper (10). As can be seen from the figure the cot bumper (10) comprises inter alia the external surface of the cot bumper body (1,2,3,4,5) A lower side zipper (13) that allows the removal of the external cover of the system for cleaning purpose. A dedicated space for placing an audio source, such as a CD, DVD, MP3 or MP4 player, is marked by (12).

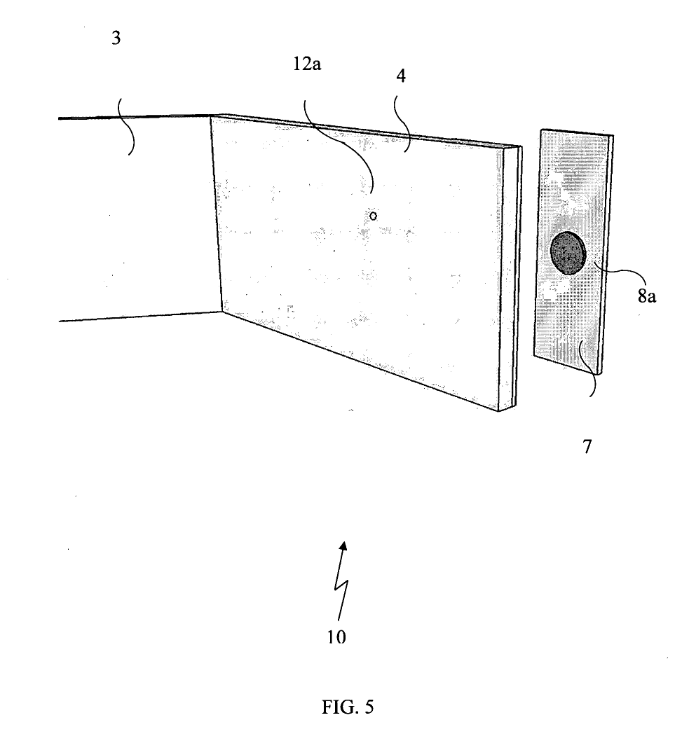

Reference is now made to FIG. 5 which illustrates a side view of the cot bumper according to the present invention. As can be seen from the figure the cot bumper comprises inter alia the internal surface of the cot bumper body (3, 4) and a speaker (8a) mounted on the mounting plate (7). The wiring connection hub is indicated by (12a).

The length of the cot bumper body (3, 4) may vary from about 40 cm to about 100 cm.

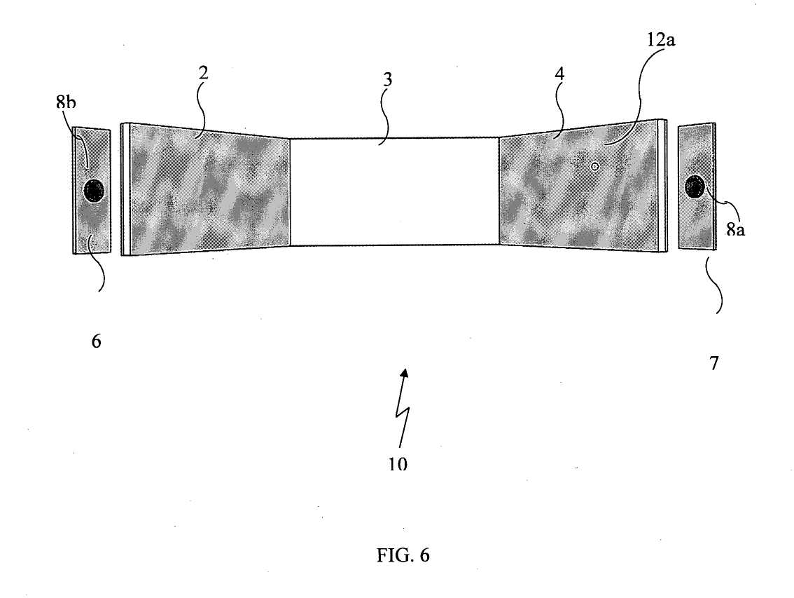

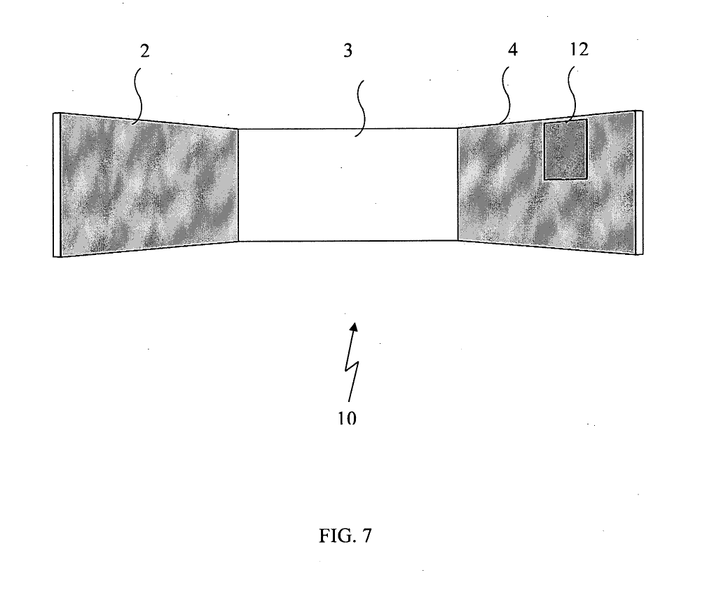

Reference is now made to FIG. 6, illustrating an internal view of the cot bumper according to the present invention. As already describe the cot bumper comprises inter alia from the internal surface of the cot bumper body (2, 3, 4), speakers (8a, 8b) mounted on mounting plates (6,7). The wiring connection hub is indicated by (12a). The dimensions of the cot bumper may vary from about 40 cm to about 100 cm. Reference is now made to FIG. 7, displaying an external view of the cot bumper according to the present invention. The cot bumper comprises inter alia from internal surface of the cot bumper body (2, 3, 4), a dedicated space (12) for placing an audio source, such as a CD, DVD, MP3 or MP4 player.

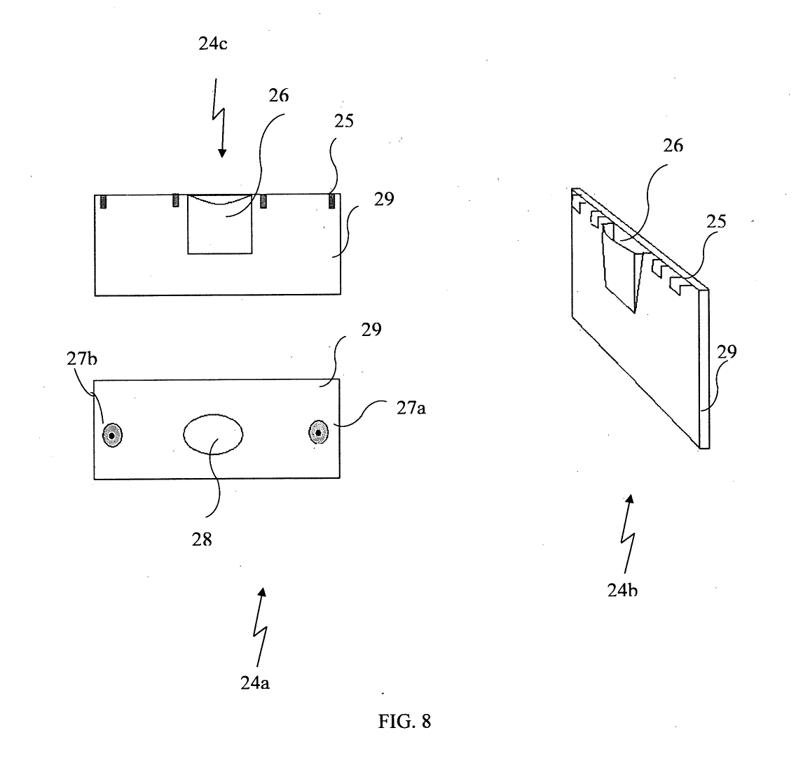

Reference is now made to FIG. 8, illustrating an internal view (24a); a side view (24b) and an external view (24c) of the cot bumper (29), according to the present invention. As can be seen from the figure, the cot bumper comprises inter alia a mirror on the internal surface (28); clips on the external surface (25); speakers (27a, 27b) and a dedicated space for placing an audio source, such as a CD, DVD, MP3 or MP4 player (26).

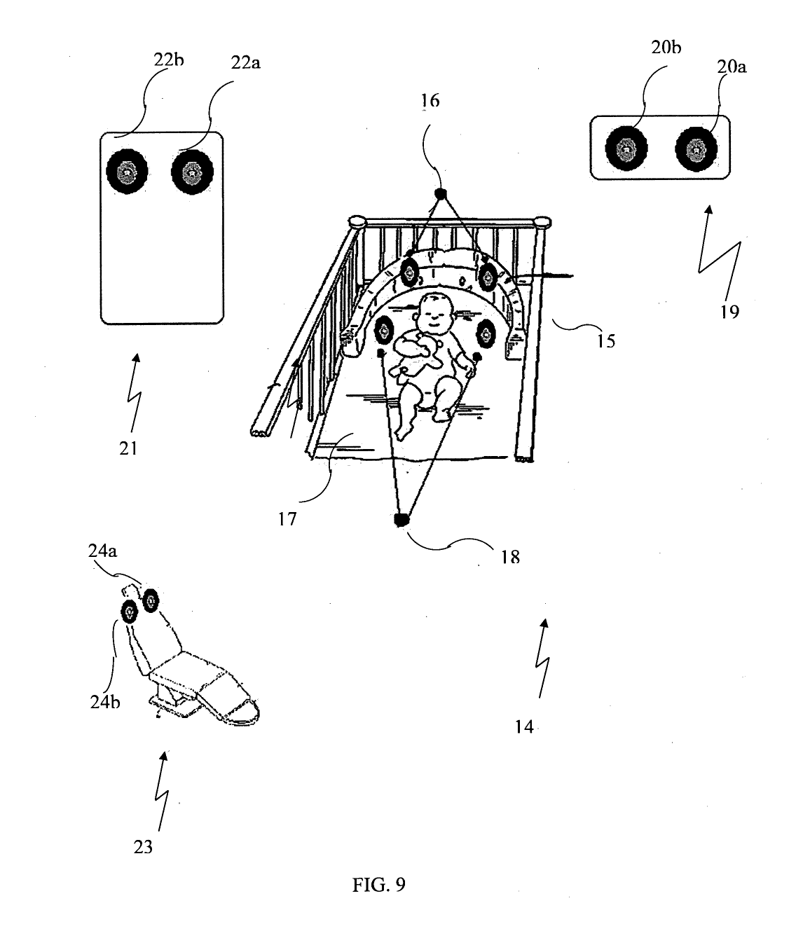

Reference is now made to FIG. 9, illustrating an audio enabled bedding system according to the present invention. As can be seen from the figure, the audio enabled bedding system comprises inter alia, a baby cot (14), which contains a cot bumper (15) integrated with speakers (16). Also presented in FIG. 5 is a mattress (17) integrated with speakers (18), a bed cover (21) integrated with speakers (22a, 22b), a pillow (19) integrated with speakers (20a, 20b). The present invention may be utilized in a dental chair (23). The dental chair (23) is integrated with speakers (24a, 24b). Internal electrical wiring of items (17, 19, 21, 23) is identical to the method illustrated in FIG. 2, and may be done by wireless technology.

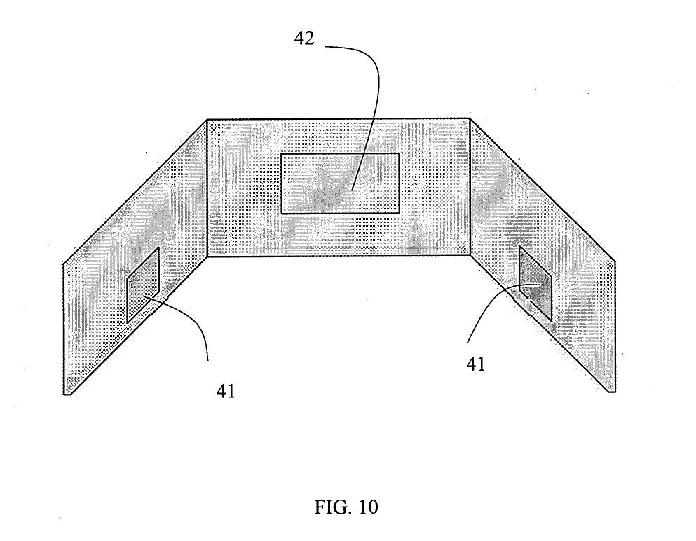

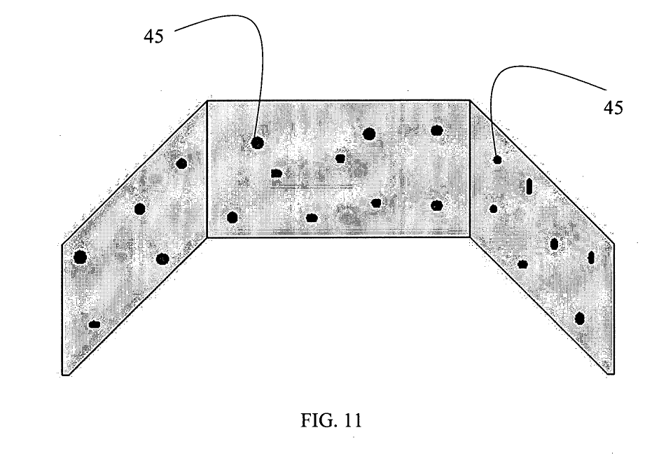

Reference is now made to FIG. 10 which illustrates the cot bumper according to yet another embodiment of the present invention. As can be seen, the cot bumper comprises a DVD system 42 and at least one screen 41. Screens 41 are located in the internal wall (or body of the cot bumper). The screens are installed such that no damage might be caused to the person if the screens break. FIG. 10 displays one embodiment of the present invention in which two screens 41 are located in the cot bumper's body. Both screens 41 are allowing any person to enrich and improve his experience while in the bedding system. Screens 41, the DVD system 42 and the speakers are allowing experience in both the visual sense and in the visual sense. Reference is now made to FIG. 11 which illustrates the cot bumper according to yet another embodiment of the present invention. As can be seen, the cot bumper comprises leads (or any kind of lighting) 45. Leads 45 are in many different colors and are connected or activated by a voice sensor (not shown) and are darting according to the music rhythm which is played. The may be configured in any shape or form. They can spread on the cot bumper body or organized in a particular shape.

1-84. (canceled)

85. A bedding system (BS) adapted to be used by any person comprising:
a. a bedding article; and
b. at least one audio/video means,
wherein said audio/video means is integrated within said bedding article.

86. The BS according to claim 85, comprising at least one, at least partially continuous, integrating portion wherein said integrating portion is interconnected with said audio/video means in at least a temporary or reversible manner.

87. The BS according to claim 85, wherein said audio/video means comprises at least one speaker; further wherein said at least one speaker is arranged in one or a combination of the following group of configurations: mono, surround, stereo or quadro.

88. The BS according to claim 85, wherein said audio/video means additionally comprises at least one selected from a group consisting of (a) display means; (b) at least one audio/video player selected from a group consisting of radio receiver, CD, DVD, MP3 or MP4 player; (c) at least mirror embedded in said bedding article; or any combination thereof.

89. The BS according to claim 85, wherein said BS is either wirelessly or cordially connected to an adult bed, or any other part of an adult sleeping environment or bedding.

90. The BS according to claim 85, wherein said BS is especially adapted for at least one selected from a group consisting of dental clinics, comprising a part of a dental chair or of a dental chair cover; medical or surgical clinics and hospitals, especially obstetrics or gynecology clinics, ear nose and throat clinics; ophthalmology clinics, surgical and orthopedic clinics and operating theatres; utilized in a driver's chair or passenger's chair, fitted to use within any driving or transportation environment or a vehicle; utilized within a wheelchair, a hospital bed, or rehabilitation bed and adapted for use by sick, injured, debilitated or handicapped people or any combination thereof.

91. The BS according to claim 85, wherein said BS is especially adapted for operation by at least one selected from a group consisting of an automatic timer, which may be mechanical, electromechanical, digital, or computerized and controlled by software; an automatic programmable electrical, digital, computerized or combination thereof feedback mechanism which controls operation parameters such as on/off switching; volume; rhythm; vibration amplitude, frequency and music style or any combination thereof.

92. The BS according to claim 91, wherein said feedback mechanism receives one or more of the following group of input parameters; recognition of cry, movement frequency and amplitude, breathing rate, perspiration index, heart rate, brain electrical activity (EEG), and various other physiological parameters; or any combination thereof.

93. The BS according to claim 85, wherein said BS additionally comprising a monitor adapted to sense at least one selected from a group consisting of respiration rate, or sounds, recognition of cry, or any combination thereof; said monitor is connectable to an alarm system adapted to be activated in case of respiratory, cardiac failure or cry.

94. The BS according to claim 85 further comprising:
a. a wireless transmitter; and
b. a wireless receiver,
wherein said wireless transmitter is located within or in close proximity to said bedding article; further wherein said wireless transmitter is triggered by voice; further wherein said wireless receiver controls said audio/video means.

95. The BS in claim 94 wherein said wireless transmitter is designed to mute said audio/video means whilst transmitting; further wherein said wireless transmitter comprises a microphone and broadcasts the sounds collected by said microphone.

96. The BS according to claim 94 further comprising a means to sense Sudden Infant Death (SID) syndrome events occurring to an infant using said BS; further wherein said transmitter is provided with means to sound or transmit an alarm signal upon receiving indication of a Sudden Infant Death (SID) syndrome event taking place.

97. The bedding system (BS) (10) according to claim 85, comprising
a. a cot bumper body (1-5); said cot bumper further comprises:
1. acrylic fibers filling;
2. two rigid foamed polyurethane plates; and
3. external removable cotton linen cover;
b. at least one pouch (12);
c. at least one compartment; and
d. at least one speaker (8a, 8b), mountable on mounting plates (6, 7) and interconnected to at least one audio port, and
wherein said cot bumper is provided with means of integrating said at least one speaker, and said at least one pouch is provided with means for connection and storage of an audio player; further wherein said at least one compartment is located on said cot bumper body for insertion of the mounted speakers into said cot bumper.

98. The BS according to claim 85, especially adapted to at least one selected from mattress, pillow, chair, or any combination thereof; each of which comprising a plurality of audio/video means and interconnected by one or more integrating portions and further comprising at least one external connection port.

99. A method of delivering audio/video content to at least one person comprising the steps of:
a. providing a bedding system (BS) adapted to be used by any person comprising:
1. a bedding article; and
2. at least one audio/video means,
said BS is either wirelessly or cordially connected to an adult bed, or any other part of an adult sleeping environment or bedding; wherein said audio/video means is integrated within said bedding article, and
b. placing said person on or near said BS, and
c. activating said audio/video means to deliver said audio/video content.

100. The method of delivering audio/video content to at least one person according to claim 99, additionally comprising step of providing said audio/video means with at least one selected from (a) at least one display means; (b) at least one audio/video player selected from a group consisting of radio receiver, CD, DVD, MP3 or MP4 player; (c) at least one audio/video recorder; (d) with at least one speaker; further wherein said at least one speaker is arranged in one or a combination of the following group of configurations: mono, surround, stereo or quadro; (e) monitor adapted to sense at least one selected from a group consisting of respiration rate or sounds, recognition of cry, or any combination thereof; said monitor is connectable to an alarm system adapted to be activated in case of respiratory or cardiac failure or cry; (f) at least one mirror embedded in said bedding article; or any combination thereof.

101. The method of delivering audio/video content to at least one person according to claim 99, wherein said BS is especially adapted for operation by at least one selected from a group consisting of an automatic timer, which maybe mechanical, electromechanical, digital, or computerized and controlled by software; an automatic programmable electrical, digital, computerized or combination thereof feedback mechanism which controls operation parameters selected from on/off switching; volume; rhythm; vibration amplitude, frequency and music style or any combination thereof; further wherein said feedback mechanism receives one or more of the following group of input parameters; recognition of cry, movement frequency and amplitude, breathing rate, perspiration index, heart rate, brain electrical activity (EEG), and various other physiological parameters; and any combinations of them.

102. The method of delivering audio/video content to at least one person according to claim 99, further comprising the steps of providing said BS with:
a. a wireless transmitter, comprises a microphone and broadcasts the sounds collected by said microphone; and
b. a wireless receiver,
wherein said wireless transmitter is located within or in close proximity to said bedding article; further wherein said wireless transmitter is triggered by voice.

103. The method of delivering audio/video content to at least one person according to claim 99, further comprising the step of providing said BS with means adapted to sense Sudden Infant Death (SID) syndrome events occurring to an infant using said BS; further wherein said transmitter is provided with means to sound an alarm signal upon receiving indication of a Sudden Infant Death (SID) syndrome event taking place.

104. The method of delivering audio/video content to at least one person according to claim 99, wherein said BS is especially adapted for at least one selected from a group consisting of dental clinics, a part of a dental chair or of a dental chair cover, medical or surgical clinics and hospitals, especially obstetrics or gynecology clinics, ear nose and throat clinics; ophthalmology clinics, surgical and orthopedic clinics and operating theatres, driver's chair or passenger's chair, fitted to use within any driving or transportation environment or a vehicle, wheelchair, a hospital bed, or rehabilitation bed and adapted for use by sick, injured, debilitated or handicapped people or any combination thereof.
